(19) United States
(12) Patent Application Publication
(10) Pub. No.: US 2008/0170558 A1
(43) Pub. Date: Jul. 17, 2008

(54) TECHNIQUES FOR TRANSMISSION PROTECTION FOR WIRELESS NETWORKS

(75) Inventors: Jari Jokela, Ylojarvi (FI); Mikko Jaakkola, Lempaala (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo, FL (US)

(21) Appl. No.: 11/972,302

(22) Filed: Jan. 10, 2008

Related U.S. Application Data
(60) Provisional application No. 60/884,976, filed on Jan. 15, 2007.

(51) Int. Cl. H04B 7/212

(52) U.S. Cl. 370/348

(57) ABSTRACT

Various embodiments are disclosed relating to techniques for protecting transmissions in a wireless network. According to an example embodiment, it may be determined at a wireless node whether the wireless node is exchanging transmissions with a plurality of wireless devices associated with a plurality of different signal types in a wireless network. An extended protection request may be sent from the wireless node to a first transmitting device to defer transmission of information for the wireless node for a requested deferral duration. The first transmitting device may defer transmission of information for the wireless node during a deferral period corresponding to the requested deferral duration in response to the extended protection request.

### CROSS REFERENCE TO RELATED APPLICATIONS

This application claims the benefit under 35 U.S.C. § 119(e) of U.S. Provisional Patent Application Ser. No. 60/884,976 filed on Jan. 15, 2007. The entire disclosure of U.S. Provisional Application 60/884,976 is incorporated by reference herein in its entirety.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. Other wireless technologies are being developed, such as IEEE 802.16 or WiMAX technology. A number of different 802.11 task groups are involved in developing specifications relating to improvements to the existing 802.11 technology. A specification from the IEEE 802.11e Task Group has proposed a set of QoS parameters to be used for traffic between an Access Point and a station. See, e.g., Tim Godfrey, “Inside 802.11e: Making QoS A Reality Over WLAN Connections,” CommsDesign, Dec. 19, 2003. These are a few examples of wireless network specifications or proposed standards, and there are many other wireless technologies and standards being developed.

A number of wireless standards allow stations to access a channel through a contention based channel access mechanism, where wireless nodes may contend for channel access (or access to the wireless-medium). For example, in WiMedia Distributed MAC specification, this channel access technique is referred to as prioritized contention access (PCA), where contention access is provided using different access categories (ACs), or traffic priorities.

In some wireless networks (such as 802.11 Wireless LAN networks as an example), virtual carrier-sense and physical carrier-sense functions may be used to determine the availability of the shared medium or channel. For example, the medium may be considered to be idle in some cases when both of these two functions indicate that the medium is idle. While the physical carrier-sense function uses the physical layer to sense the carrier, the virtual carrier-sense function is based on the Network Allocation Vector (NAV). For example, most IEEE 802.11 frames may carry a duration/ID field, which may be used to reserve the medium (or channel) for a fixed time period. The NAV may be considered a timer that indicates the amount of time for which the medium has been reserved. Transmitting nodes may typically set the NAV (using the duration/ID field in frames) to the time for which they expect to use the medium, including the transmission time of all the frames in a sequence. Other nodes in the network may set up a process to count down the NAV (a locally stored copy of the NAV information). When the NAV is greater than zero, the virtual carrier-sense function indicates that the medium is busy. When the NAV reaches zero, the medium is reported to be idle.

In addition, wireless nodes may use a Request-to-Send (RTS) and Clear-to-Send (CTS) exchange to request permission or clearance to use the medium or channel. A requesting node may typically send a RTS, and then receive a CTS. The CTS, may indicate that the channel or medium is idle or available and may serve to warn other nodes that the medium is now busy, since the RTS and CTS frames also typically include a duration field. The use of RTS/CTS may provide increased protection for a frame since a RTS/CTS exchange may decrease the likelihood of a collision with another frame. The NAV mechanism and/or the RTS/CTS exchange may be used in wireless networks to reduce frame collisions and to reduce hidden-node problems.

When a node needs to distribute NAV information, for instance, to reserve the medium for a transmission of a non-basic rate frame (that may not be heard by other nodes in the BSS), the node may first transmit a CTS frame with a receiving address (RA) field equal to its own MAC address (CTS-to-self) and with a duration value that protects the pending transmission, plus possibly an ACK frame.

The CTS-to-self NAV distribution mechanism may be lower in network overhead cost than is the RTS/CTS NAV distribution mechanism, but CTS-to-self may be less robust against hidden nodes and collisions than RTS/CTS. STAs employing a NAV distribution mechanism may thus choose a mechanism such as CTS-to-self or RTS/CTS that is appropriate for the given network conditions. If errors occur when employing a CTS-to-self technique, STAs may switch to a more robust mechanism.

Multiradio terminals may present challenges in controlling the radio activity of each radio system in order to optimize overall performance. For example, Bluetooth and WLAN radios may operate in the same frequency band. Furthermore, in some example implementations Bluetooth and wireless local area network (WLAN) radios may, share the same antenna. Thus, time domain scheduling may be needed in order to communicate simultaneously with both systems. For example, Bluetooth may include a fixed frame structure, and thus the TX and RX slots may be predetermined. However, a channel access protocol for WLAN may be contention based, and thus there may be no fixed time slots for TX and RX. Contention based access protocol may thus cause problems if there is a need to control the timing of WLAN TX and RX activity such that it does not overlap with Bluetooth TX and RX slots. A wireless station (STA) or wireless terminal may control when it is sending (TX) data to a WLAN access point (AP) but may not have any means to control when the WLAN AP is sending (e.g., RX from the terminal point of view) data to the terminal. This may cause significant frame losses or degradation of performance as the Bluetooth and WLAN transmissions may collide.

### SUMMARY

Various embodiments are disclosed relating to wireless networks, and also relating to techniques for transmission protection for wireless networks.

According to an example embodiment, it may be determined at a wireless node whether the wireless node is exchanging transmissions with a plurality of wireless devices associated with a plurality of different signal types in a wireless network. An extended protection request may be sent from the wireless node to a first transmitting device to defer transmission of information for the wireless node for a requested deferral duration. The first transmitting device may defer transmission of information for the wireless node during a deferral period corresponding to the requested deferral duration in response to the extended protection request.

According to another example embodiment, an extended protection request to defer transmission of information for the wireless node in a wireless network for a requested deferral duration may be received from a wireless node at a transmitting device. Transmission of information for the wireless node may be deferred during a deferral period corresponding to the requested deferral duration at the transmitting device in response to the extended protection request, wherein the wireless node is exchanging transmissions with a plurality of wireless devices associated with a plurality of different signal types.

According to another example embodiment, an apparatus may be provided in a wireless node. The apparatus may be configured to: determine whether the wireless node is exchanging transmissions with a plurality of wireless devices associated with a plurality of different signal types, and send an extended protection request to a first transmitting device to defer transmission of information for the wireless node for a requested deferral duration, wherein the first transmitting device defers transmission of information for the wireless node during a deferral period corresponding to the requested deferral duration at the first transmitting device in response to the extended protection request.

According to another example embodiment, an apparatus may be provided in a wireless node. The apparatus may be configured to: receive from a second wireless node an extended protection request to defer transmission of information for the second wireless node in a wireless network for a requested deferral duration, and defer transmission of information for the second wireless node during a deferral period corresponding to the requested deferral duration at the first wireless node in response to the extended protection request, wherein the second wireless node exchanges transmissions with a plurality of wireless devices associated with a plurality of different signal types.

The details of one or more implementations are set forth in the accompanying drawings and the description below. Other features will be apparent from the description and drawings.

### BRIEF DESCRIPTION OF THE DRAWINGS

FIG. 1 is a block diagram illustrating a wireless network according to an example embodiment.

FIG. 2 is a flow chart illustrating operation of a wireless node according to an example embodiment.

FIG. 3 is a flow chart illustrating operation of a wireless node according to another example embodiment.

FIG. 4 illustrates an example extended protection request including a data frame according to an example embodiment.

FIG. 5 is an example timing diagram according to an example embodiment.

FIG. 6 illustrates an example extended protection request including a protection request according to an example embodiment.

FIG. 7 is an example timing diagram according to an example embodiment.

FIG. 8 is an example timing diagram according to an example embodiment.

FIG. 9 illustrates an example capability information element according to an example embodiment.

FIG. 10 is a block diagram illustrating an apparatus that may be provided in a wireless node according to an example embodiment.

### DETAILED DESCRIPTION

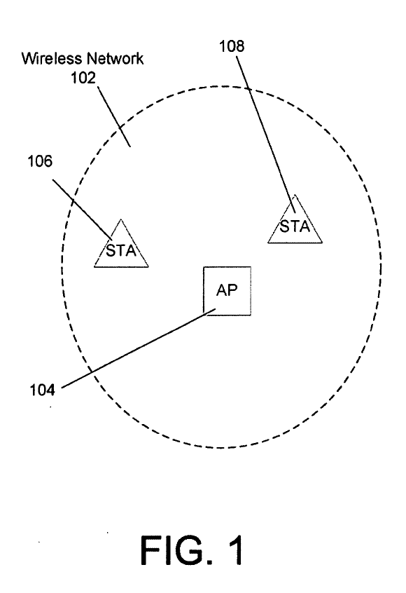

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station and one or more mobile stations or subscriber stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks. Further, each station 106, 108 may transmit information to the AP 104 as uplink (UL) transmissions, and the AP 104 may transmit information to each station 106, 108 as downlink (DL)transmissions.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various embodiments described herein, and this disclosure is not limited thereto.

Wireless nodes may use a Request-to-Send (RTS) and Clear-to-Send (CTS) exchange to request permission or clearance to use the medium or channel. A requesting node may typically send a RTS, and then receive a CTS, which may indicate that the channel or medium is idle or available and may serve to warn other nodes that the medium is now busy. The RTS and CTS frames may also include a duration field, and thus, may reserve the medium using the NAV. The use of RTS/CTS may provide increased protection for a frame since a RTS/CTS exchange may decrease the likelihood of a collision with another frame. Transmitting a frame using a RTS/CTS exchange (e.g., send a RTS, receive a CTS, and then transmit the protected frame) may, therefore, be referred to as transmitting a frame using a Request-to-Send/Clear-to-Send (RTS/CTS) protection. To limit the overhead, RTS/CTS protection may typically be used only for frames that exceed, a size threshold.

According to an example embodiment, protection mechanisms in wireless networks such as WLAN networks may be provided to minimize transmission and reception problems occurring, for example, in multiradio terminals. For example, downlink transmissions from a WLAN AP to the WLAN terminal may be controlled, as discussed below.

WLAN CTS-to-self frames may provide an example technique to protect a forthcoming WLAN UL transmission (if any) and Bluetooth (BT) (or any other radio system) transmissions. However, CTS-to-self techniques may set the NAV of every receiver and may thus silence, more or less, a complete BSS. These techniques may thus negatively impact BSS capacity, especially in moderately loaded networks.

Additionally, power save techniques, for example, 802.11 power save techniques may be used to minimize adverse effects of the multiradio problem. However, even though a station or terminal may control when it sends a UL powersave (PS) Poll or Trigger Frame the DL transmission may not be deterministic (i.e., the delay between a UL trigger and a DL transmission may not be constant, but may instead be a function of system load and channel access parameters).

According to an example embodiment, information may be included, for example, in 802.11 frames to request that the AP may not send anything for a predetermined time period after the completion of a current frame exchange. This information may be set by the station (STA) or terminal and may be used by the AP.

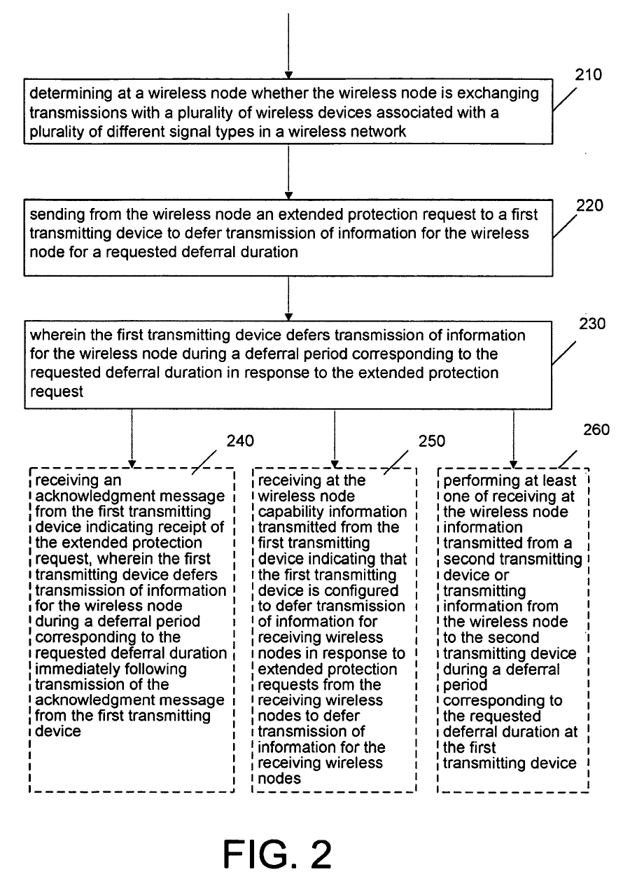

FIG. 2 is a flow chart illustrating operation of a wireless node according to an example embodiment. According to an example embodiment, it may be determined at a wireless node whether the wireless node is exchanging transmissions with a plurality of wireless devices associated with a plurality of different signal types in a wireless network (210). For example, the STA 106 may determine that it is receiving and/or transmitting both WLAN and Bluetooth signals. For example, the STA 106 may determine that it is receiving WLAN signals in DL transmission from the AP 104, and may further determine that it is receiving signals from a Bluetooth device. Alternatively, a wireless node may determine that it is exchanging transmissions with a plurality of devices by determining that the wireless node is receiving at least one degraded transmission from one of the wireless devices in the wireless network.

An extended protection request may be sent from the wireless node to a first transmitting device to defer transmission of information for the wireless node for a requested deferral duration (220). For example, the STA 106 may send an extended protection request to the AP 104, requesting the AP 104 defer transmission of information for the STA 106 for a requested deferral duration. For example, the requested deferral duration may correspond to a time needed by the STA 106 to engage in other radio activity such as receiving and/or transmitting Bluetooth signals.

For example, the wireless node may request, via the extended protection request, that the first transmitting device not send anything to the wireless node until a per-station NAV has expired.

According to an example embodiment, a data message including an indication of a requested length of time for the first transmitting device to defer transmission of information for the wireless node may be sent from the wireless node.

According to another example embodiment, an extended protection request message including an indication of a requested length of time for the first transmitting device to defer transmission of information for the wireless node may be sent from the wireless node. According to an example embodiment, the extended protection request message may include one of a control frame or a management frame. According to another example embodiment, the extended protection request may include an identification of the wireless node and/or an identification of the transmitting device.

The first transmitting device may defer transmission of information for the wireless node during a deferral period corresponding to the requested deferral duration in response to the extended protection request (230). For example, the AP 104 may defer transmission of information for the STA 106 during a deferral period corresponding to the requested deferral duration at the AP 104 in response to the extended protection request. For example, the first transmitting device may send no transmissions to the wireless node during the deferral period. For example, the first transmitting device may not transmit anything to the wireless node during the deferral period.

According to an example embodiment, an acknowledgment message may be received from the first transmitting device indicating receipt of the extended protection request, wherein the first transmitting device may defer transmission of information for the wireless node during a deferral period corresponding to the requested deferral duration immediately following transmission of the acknowledgment message from the first transmitting device (240). For example, the AP 104 may transmit an ACK message to the STA 106 indicating receipt of the extended protection request, and the AP 104 may defer transmission of information for the STA 106 during a deferral period corresponding to the requested deferral duration immediately following transmission of the ACK message from the AP 104.

According to an example embodiment, capability information transmitted from the first transmitting device may be received at the wireless node indicating that the first transmitting device is configured to defer transmission of information for receiving wireless nodes in response to requests from the receiving wireless nodes to defer transmission of information for the receiving wireless nodes (250). According to an example embodiment, the capability information may be included in a capability information element transmitted from the first transmitting device indicating that the first transmitting device is configured to defer transmission of information for receiving wireless nodes in response to requests from the receiving wireless nodes to defer transmission of information for the receiving wireless nodes.

According to an example embodiment, at least one of receiving at the wireless node information transmitted from a second transmitting device, or transmitting information from the wireless node to the second transmitting device during a deferral period corresponding to the requested deferral duration at the first transmitting device, may be performed (260). For example, the STA 106 may receive information transmitted from a Bluetooth transmitting device during the deferral period at the AP 104.

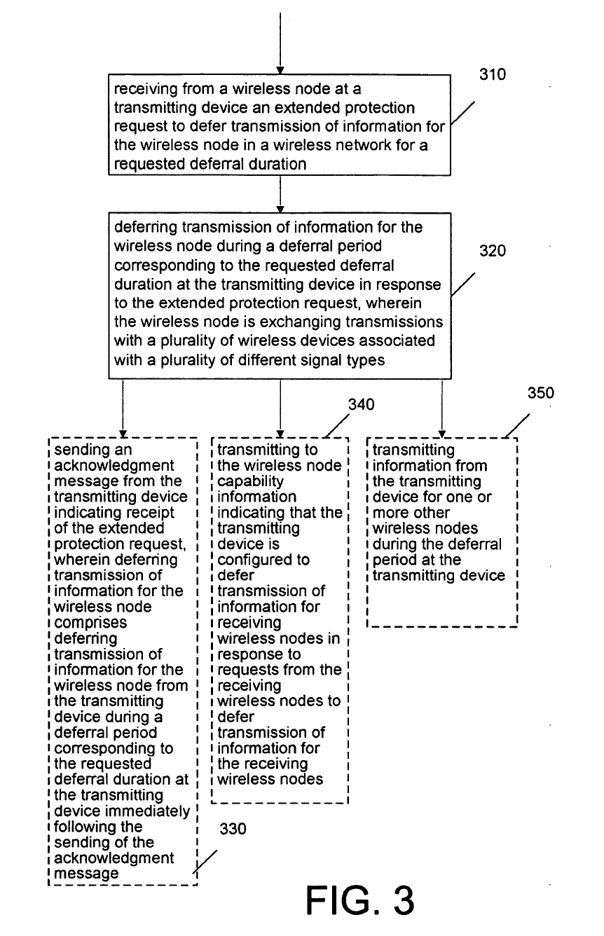

FIG. 3 is a flow chart illustrating operation of a wireless node according to another example embodiment. According to an example embodiment, an extended protection request to defer transmission of information for the wireless node in a wireless network for a requested deferral duration may be received from a wireless node at a transmitting device (310). For example, the AP 104 may receive an extended protection request from the STA 106, requesting the AP 104 to defer transmission of information for the STA 106 for a requested deferral duration. For example, the requested deferral duration may correspond to a time needed by the STA 106 to engage in other radio activity such as receiving and/or transmitting Bluetooth signals.

For example, the wireless node may request, via the extended protection request, that the transmitting device not send anything to the wireless node until a per-station NAV has expired.

Transmission of information for the wireless node may be deferred during a deferral period corresponding to the requested deferral duration at the transmitting device in response to the extended protection request, wherein the wireless node is exchanging transmissions with a plurality of wireless devices associated with a plurality of different signal types (320). For example, the AP 104 may defer transmission of information to the STA 106 during a deferral of transmission of information for the STA 106 at the AP 104 in response to the extended protection request. For example, the transmitting device may send no transmissions to the wireless node during the deferral period. For example, the transmitting device may not transmit anything to the wireless node during the deferral period.

According to an example embodiment, an acknowledgment message may be sent from the transmitting device indicating receipt of the extended protection request, wherein deferring transmission of information for the wireless node may include deferring transmission of information for the wireless node from the transmitting device during a deferral period corresponding to the requested deferral duration at the transmitting device immediately following the sending of the acknowledgment message (330). For example, the AP 104 may transmit an ACK message to the STA 106 indicating receipt of the extended protection request, and the AP 104 may defer transmission of information for the STA 106 during a deferral period immediately following transmission of the ACK message from the AP 104.

According to an example embodiment, capability information may be transmitted to the wireless node indicating that the transmitting device is configured to defer transmission of information for receiving wireless nodes in response to requests from the receiving wireless nodes to defer transmission of information for the receiving wireless nodes (340). According to an example embodiment, the capability information may be included in a capability information element transmitted to the wireless node indicating that the transmitting device is configured to defer transmission of information for receiving wireless nodes in response to requests from the receiving wireless nodes to defer transmission of information for the receiving wireless nodes.

According to an example embodiment, information may be transmitted from the transmitting device to one or more other wireless nodes during the deferral period at the transmitting device (350). For example, the AP 104 may transmit information to the STA 108 during the deferral period at the AP 104.

According to an example embodiment, protected time periods may be provided during which the access point or base station of a particular radio technology (e.g., WLAN AP) may not send any information for a terminal or station. For example, a terminal or station may control transmission times of an AP such that the AP is not transmitting information for the terminal or station while the terminal or station is engaged in other radio (technology) activity. According to an example embodiment, for example, in an example 802.11n network, an example protection field may be included in a header of a data frame to indicate a requested deferral duration, or to indicate how long a wireless node such as a terminal or station may engage in radio activities other than receiving transmissions from a transmitting device such as the AP or base station.

According to another example embodiment, for example, in an example 802.11v network, a protection frame included in an extended protection request may be sent by a wireless node such as a terminal or station to a transmitting device such as an AP or base station to indicate a requested protection time, or requested deferral duration. The requested protection time or deferral duration may indicate how long a wireless node such as a terminal or station may, for example, engage in radio activities other than receiving transmissions from a transmitting device such as the AP or base station.

According to another example embodiment, it may be determined at a wireless node whether the wireless node is exchanging a plurality of signal types in a wireless network. An extended protection request may be sent from the wireless node to a first transmitting device to defer transmission to the wireless node for a requested deferral duration. No information transmitted by the first transmitting device may be received at the wireless node during a deferral period corresponding to the deferral duration at the first transmitting device in response to the extended protection request.

According to yet another example embodiment, an extended protection request to defer transmission to the wireless node in a wireless network for a requested deferral duration may, be received from a wireless node at a transmitting device. No information may be transmitted to the wireless node during a deferral period corresponding to the deferral duration at the transmitting device in response to the extended protection request.

According to an example embodiment, one or more wireless nodes may each send extended protection requests to the transmitting device to defer transmission of information for each wireless node for a respective requested deferral duration. Thus, it is possible that the transmitting device may defer transmission of information to several wireless nodes simultaneously. Moreover, it is possible that the transmitting device may not send any information to any wireless nodes for at least a deferral duration.

According to an alternative example embodiment, even though the transmitting device may not send data frames to the wireless node, the transmitting device may transmit important other information such as control or management information to the wireless node during the requested protection time.

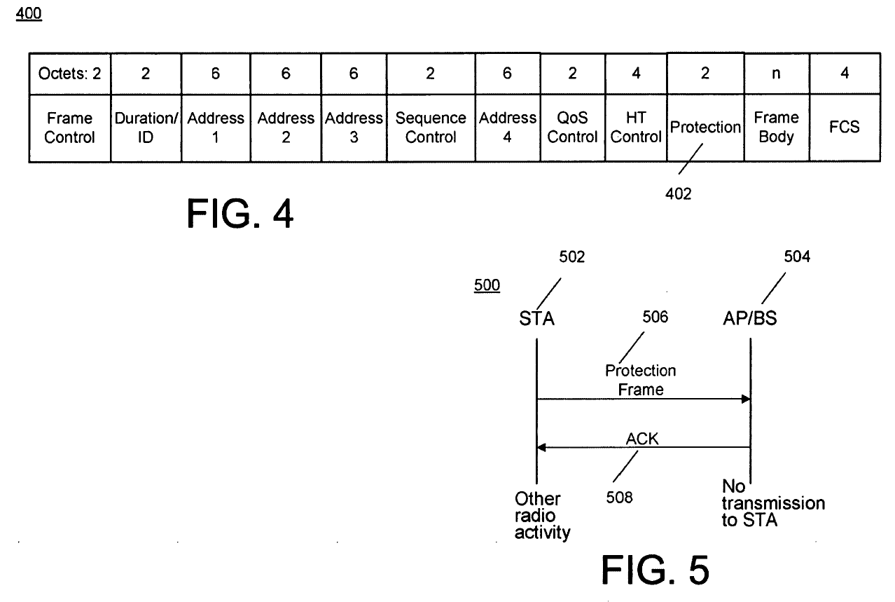

FIG. 4 illustrates an example extended protection request including a data frame 400 including a MAC header according to an example embodiment. In the example, a protection field 402 may be included, for example, after an HT Control field. Thus, the example protection field 402 may be included in a header to indicate how long a wireless node such as a terminal or station may be engaged in other radio activities (i.e., other than receiving transmissions from a particular transmitting device). For example, the HT Control field may include an 802.11n HT Control field.

As shown in FIG. 4, the example protection field 402 may be two octets long may indicate the additional protection time in microseconds. The example extra protection time may indicate a time period after the current frame exchange (e.g., protected by NAV) during which the transmitting device such as an AP may not send any frames for this particular wireless node or station or terminal. An example Duration/ID field may be used to protect the current frame exchange (or whole TXOP). The example protection field 402 may not affect the operation of other STAs in the BSS, as the other STAs in the BSS may send and receive data normally. The example protection field 402 may be used in all type of frames, for example, in data, control or management frames, or it may be used only with data frames, for example.

FIG. 5 is an example timing diagram 500 according to an example embodiment. As shown in FIG. 5, a frame exchange between a STA 502 and an AP/BS 504 may include a protection frame 506 sent from the STA 502 to the AP/BS 505. For example, an extended-protection request 400 may be sent from the STA 106 to the AP 104.

The AP 504 may send an ACK 508 to the STA 502, for example, indicating receipt of the protection frame 506. For example, the AP 104 may send an acknowledgement to the STA 106 indicating receipt of an extended protection request. The STA 502 may then engage in other radio activity, while the AP/BS 504, for example, a WLAN AP, may not transmit information for the STA 502. For example, the STA 502 may engage in Bluetooth activity, while the AP/BS 504 may not transmit information for the STA 502, thus providing protection for the Bluetooth activity at the STA 502.

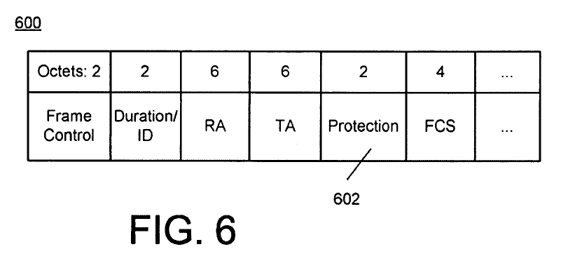

FIG. 6 illustrates an example extended protection request including a protection request 600 according to an example embodiment. As shown in FIG. 6, a protection request frame type may protect the actual WLAN transmission and other radio systems transmissions, for example, for an 802.11v network. For example, a wireless node such as a terminal or station may send the example protection request 600 to a transmitting device to indicate a protection time similarly as discussed previously, for example, with regard to FIG. 4. The example protection request frame type may include either a control or management frame type. As shown in FIG. 6, example frame fields may include Frame Control, Duration/Id, RA, TA, Extended Protection 602, and frame check sequence (FCS). The protection request 600 frame may be transmitted, for example, similarly as an example RTS frame or similarly as an example CTS-to-self frame.

For the example of FIG. 6, the Frame Control field may include type and subtype fields indicating the frame type. The Duration/Id field may protect the WLAN transmission (e.g., normal operation). The RA and TA fields may identify a receiver and a transmitter, respectively, and the Extended Protection field 602 may indicate an extended protection time similarly as discussed previously with regard to the protection field 402 of FIG. 4. The example FCS field may be used to protect the protection request frame 600. According to an example embodiment as discussed below with regard to FIG. 8, the TA field may be set to a predetermined reserved value, as only the RA field may be needed to identify a receiver.

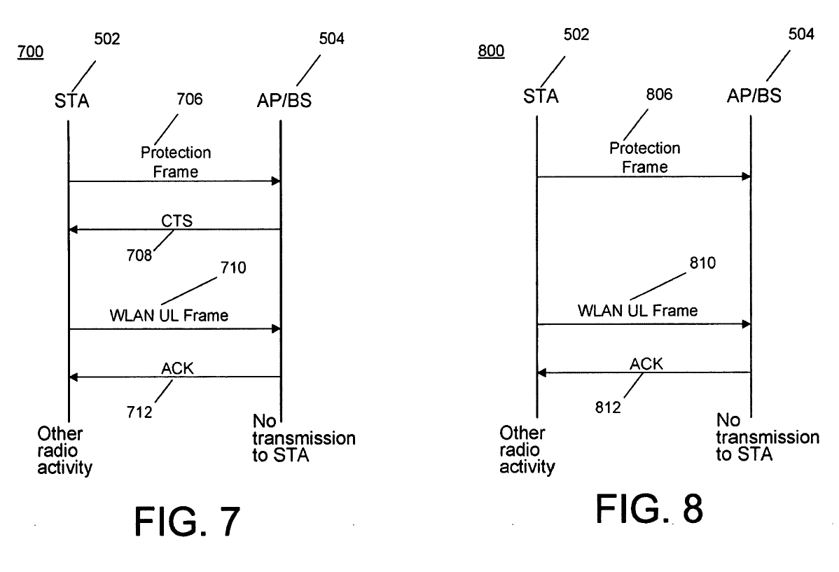

FIG. 7 is an example timing diagram 700 according to an example embodiment. As shown in FIG. 7, a frame exchange between the STA 502 and the AP/BS 504 may include a protection frame 706 sent from the STA 502 to the AP/BS 504. For example, an extended protection request, 600 may be sent from the STA 106 to the AP 104 similarly to sending an RTS frame to the AP 104. In response, similarly to an RTS exchange, a CTS 708 may be sent from the AP/BS 504 to the STA 502.

An actual WLAN UL frame 710 may be sent by the STA 502 to the AP/BS 504. An acknowledgment or ACK 712 may then be sent from the AP/BS 504 to the STA 502 indicating receipt of the WLAN UL frame 710. The STA 502 may then engage in other radio activity, while the AP/BS 504, for example, a WLAN AP may not transmit information for the STA 502. According to an example embodiment, the protection frame 706 may also be sent without any UL data.

FIG. 8 is an example timing diagram 800 according to an example embodiment. As shown in FIG. 8, a frame exchange between the STA 502 and the AP/BS 504 may include a protection frame 806 sent from the STA 502 to the AP/BS 504. For example, an extended protection request 600 may be sent from the STA 106 to the AP 104 similarly to sending an example CTS-to-self frame.

An actual WLAN UL frame 810 may be sent by the STA 502 to the AP/BS 504. An acknowledgment or ACK 812 may then be sent from the AP/BS 504 to the STA 502 indicating receipt of the WLAN UL frame 810. The STA 502 may then engage in other radio activity, while the AP/BS 504, for example, a WLAN AP may not transmit information for the STA 502. According to an example embodiment, the protection frame 806 may also be sent without any UL data.

According to another example embodiment, the example ACK 812 may not be sent by the AP to the STA before the deferral of transmission of information from the AP/BS 504 to the STA 502 (i.e., the ACK 812 may be omitted), if no UL data is transmitted.

Thus, as discussed previously, a base station or access point (or relay station) of another radio technology may be prevented from transmitting information for a terminal or station while the terminal or station is engaged in “other” radio activity.

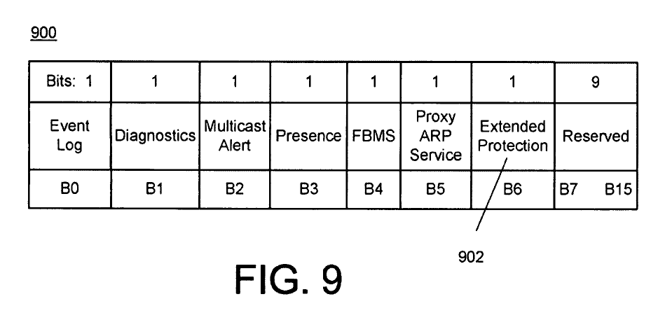

FIG. 9 illustrates an example capability information element 900 for inclusion in an example extended protection frame, according to an example embodiment. As shown in FIG. 9, the example capability information element 900 may include an extended protection field 902 which may indicate, for example, that a base station (BS) or access point (AP) may be configured to receive extended protection requests from other wireless nodes, and to defer transmission of information for those other wireless nodes for periods indicated by the respective extended protection requests. Capabilities may be negotiated, for example, during an association or re-association phase, and the extended protection frames may be used after the negotiation is completed. An example AP may use Beacon and Probe Response frames to advertise its support of this feature. Similarly, a terminal or station may indicate its capability, for example, via Probe Request frames. A capability to support the example extended protection technique may be indicated, for example, via an 802.11v Wireless Network Management Capability information element. Below is an example illustrating how the extended protection capability can be included into this element. One skilled in the art of data communications will appreciate that there are many other ways to advertise the capability.

As discussed above, example techniques for protecting DL transmissions may provide simple control of WLAN AP DL transmissions. These example techniques may be robust, with no need to maintain synchronization as every frame may include extra protection information. Additionally, the example techniques may not affect operation of other terminals or stations in the wireless network.

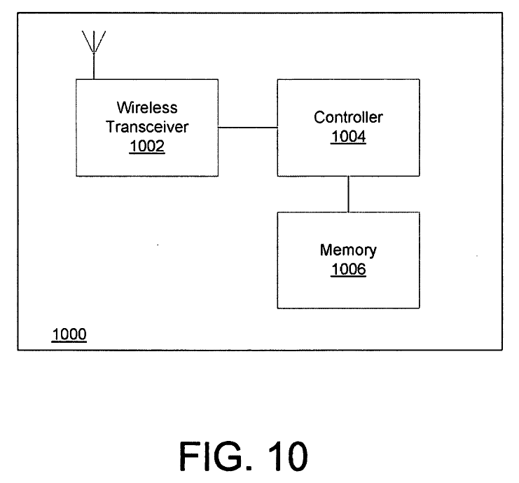

FIG. 10 is a block diagram illustrating an apparatus 1000 that may be provided in a wireless node according to an example embodiment. The wireless node (e.g. station or AP) may include, for example, a wireless transceiver 1002 to transmit and receive signals, a controller 1004 to control operation of the station and execute instructions or software, and a memory 1006 to store data and/or instructions.

Controller 1004 may be programmable and capable of executing software or other instructions stored in memory or on other computer media to perform the various tasks and functions described above, such as one or more the tasks or methods described above in FIGS. 1-9.

In addition, a storage medium may bet provided that includes stored instructions, when executed by a controller or processor that may result in the controller 1004, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art.

What is claimed is:

1. A method comprising:
determining at a wireless node whether the wireless node is exchanging transmissions with a plurality of wireless devices associated with a plurality of different signal types in a wireless network; and
sending from the wireless node an extended protection request to a first transmitting device to defer transmission of information for the wireless node for a requested deferral duration, wherein
the first transmitting device defers transmission of information for the wireless node during a deferral period corresponding to the requested deferral duration in response to the extended protection request.

2. The method of claim 1, wherein the determining comprises determining at the wireless node whether the wireless node is receiving at least one degraded transmission from one of the wireless devices in the wireless network.

3. The method of claim 1, wherein the determining comprises determining at a wireless station whether the wireless station is exchanging transmissions with the plurality of wireless devices in the wireless network.

4. The method of claim 1, wherein the sending comprises sending from the wireless node the extended protection request to a wireless access point to defer transmission of information for the wireless node for the requested deferral duration.

5. The method of claim 1, wherein the sending comprises sending from the wireless node a data message including an indication of a requested length of time for the first transmitting device to defer transmission of information for the wireless node.

6. The method of claim 1, wherein the sending comprises sending from the wireless node an extended protection request message including an indication of a requested length of time for the first transmitting device to defer transmission of information for the wireless node, wherein the extended protection request message includes one of a control frame or a management frame.

7. The method of claim 1, further comprising:
receiving an acknowledgment message from the first transmitting device indicating receipt of the extended protection request,
wherein the first transmitting device defers transmission of information for the wireless node during a deferral period corresponding to the requested deferral duration immediately following transmission of the acknowledgment message from the first transmitting device.

8. The method of claim 1, further comprising:
receiving at the wireless node capability information included in a capability information element transmitted from the first transmitting device indicating that the first transmitting device is configured to defer transmission of information for receiving wireless nodes in response to extended protection requests from the receiving wireless nodes to defer transmission of information for the receiving wireless nodes.

9. A method comprising:
receiving from a wireless node at a transmitting device an extended protection request to defer transmission of information for the wireless node in a wireless network for a requested deferral duration; and
deferring transmission of information for the wireless node during a deferral period corresponding to the requested deferral duration at the transmitting device in response to the extended protection request, wherein
the wireless node is exchanging transmissions with a plurality of wireless devices associated with a plurality of different signal types.

10. The method of claim 9, wherein the receiving comprises receiving from the wireless node a data frame including an indication of a requested length of time for the transmitting device to defer transmission of information for the wireless node.

11. The method of claim 9, wherein the receiving comprises receiving from the wireless node an extended protection request message including an indication of a requested length of time for the transmitting device to defer transmission of information for the wireless node.

12. The method of claim 9, wherein the receiving comprises receiving from the wireless node an extended protection request message including an indication of a requested length of time for the transmitting device to defer transmission of information for the wireless node, an identification of the wireless-node, and an identification of the transmitting device, wherein the extended protection request message includes one of a control frame or a management frame.

13. The method of claim 9, further comprising:
sending an acknowledgment message from the transmitting device indicating receipt of the extended protection request,
wherein deferring transmission of information for the wireless node comprises deferring transmission of information for the wireless node from the transmitting device during a deferral period corresponding to the requested deferral duration at the transmitting device immediately following the sending of the acknowledgment message.

14. The method of claim 9, further comprising:
transmitting to the wireless node capability information indicating that the transmitting device is configured to defer transmission of information for receiving wireless nodes in response to requests from the receiving wireless nodes to defer transmission of information for the receiving wireless nodes.

15. The method of claim 9, further comprising:
transmitting information from the transmitting device for one or more other wireless nodes during the deferral period at the transmitting device.

16. An apparatus provided in a wireless node, the apparatus configured to:
determine whether the wireless node is exchanging transmissions with a plurality of wireless devices associated with a plurality of different signal types, and
send an extended protection request to a first transmitting device to defer transmission of information for the wireless node for a requested deferral duration, wherein
the first transmitting device defers transmission of information for the wireless node during a deferral period corresponding to the requested deferral duration at the first transmitting device in response to the extended protection request.

17. The apparatus of claim 16, wherein the apparatus comprises:
a controller;
memory coupled to the controller; and
a wireless transceiver coupled to the controller.

18. The apparatus of claim 9, further configured to:
perform at least one of receiving information transmitted from a second transmitting device or transmitting information from the wireless node to the second transmitting device during a deferral period corresponding to the requested deferral duration at the first transmitting device.

19. An apparatus provided in a first wireless node, the apparatus configured to:
receive from a second wireless node an extended protection request to defer transmission of information for the second wireless node in a wireless network for a requested deferral duration; and
defer transmission of information for the second wireless node during a deferral period corresponding to the requested deferral duration at the first wireless node in response to the extended protection request, wherein
the second wireless node exchanges transmissions with a plurality of wireless devices associated with a plurality of different signal types.

20. The apparatus of claim 19, wherein the apparatus comprises:
a controller;
memory coupled to the controller; and
a wireless transceiver coupled to the controller.

21. The apparatus of claim 19, further configured to:
transmit information from the first wireless node for a third wireless node during the deferral period at the first wireless node.

22. A method comprising:
receiving from a wireless node at a transmitting device an extended protection request to defer transmission to the wireless node in a wireless network for a requested deferral duration; and
transmitting no information to the wireless node during a deferral period corresponding to the deferral duration at the transmitting device, in response to the extended protection request.

23. The method of claim 22, wherein the receiving comprises receiving from a wireless station at a wireless access point the extended protection request to defer transmission to the wireless station for the requested deferral duration.

24. The method of claim 22, wherein the receiving comprises receiving from the wireless node a data frame including an indication of a requested length of time for the transmitting device to defer transmission to the wireless node.

25. The method of claim 22, wherein the receiving comprises receiving from the wireless node an extended protection request message including an indication of a requested length of time for the transmitting device to defer transmission to the wireless node.
